(19) United States
(12) Patent Application Publication
(10) Pub. No.: US 2024/0351304 A1
(43) Pub. Date: Oct. 24, 2024

(54) PROCESS TO REGENERATE WOVEN AND KNIT FABRIC AND PRODUCT THEREFROM

(71) Applicant: Lynn Ann Wagner, Carlsbad, CA (US)

(72) Inventor: Lynn Ann Wagner, Carlsbad, CA (US)

(21) Appl. No.: 18/641,110

(22) Filed: Apr. 19, 2024

Related U.S. Application Data
(60) Provisional application No. 63/460,407, filed on Apr. 19, 2023.

(51) Int. Cl. B32B 5/06; B32B 5/02; B32B 5/08; B32B 5/26; B32B 37/10; D04H 3/10; D04H 3/115; D06B 11/00

(52) U.S. Cl. CPC B32B 5/06; B32B 5/022; B32B 5/024; B32B 5/026; B32B 5/08; B32B 5/263; B32B 5/265; B32B 5/275; B32B 5/279; B32B 5/2795; B32B 37/10; D04H 3/102; D04H 3/115; D06B 11/0059; B32B 2250/02; B32B 2250/03; B32B 2250/20; B32B 2262/02; B32B 2262/062; B32B 2262/103; B32B 2262/124; B32B 2305/182; B32B 2305/188; B32B 2305/20; D10B 2201/20

(57) ABSTRACT

The present invention provides multiple processes of making fabric composites using fabric and/or fiber waste, or virgin fabric or fiber as starting material and via a needle punching process. The fabric and/or fiber waste, or virgin fabric or fiber, are regenerated to form fabric composites for reuse.

### CROSS REFERENCE TO RELATED APPLICATIONS

The present application claims priority to U.S. Provisional patent application Ser. No. 63/460,407 filed on Apr. 19, 2023, the contents of which are incorporated herein by reference.

### FIELD OF THE PRESENT INVENTION

The present invention relates to sustainable processes of creating fabric composites using woven or knit fabrics from fabric waste as well as the fabric itself and virgin or recycled fibers.

### BACKGROUND OF THE PRESENT INVENTION

In fabric mills, warehouses, and sewing factories, there are often textile dead stock roll goods which are fabrics still on the roll. In other words, the textile dead stock roll goods are full width fabric goods on a cardboard tube. They are considered textile waste when such fabric on the roll (roll goods) is in excess, liability, aged out in storage, or result of a cancelled order, defect or second quality.

The woven or knit fabric wastes may be derived from roll goods textile wastes which are full width fabric goods on a cardboard tube. The shoddy may be derived from chopped up pre-consumer and post-consumer waste or industrial waste, such as cuttings from the garment cutting table when cutting the fabric prior to sewing. Another source of shoddy is chopped up garments or other end of life textiles that are chopped up.

The present invention develops a sustainable process for regenerating such fabric wastes to make fabric composite via a needle punching process. The sustainable process is circular instead of linear, avoiding ending life of the fabrics.

### SUMMARY OF THE PRESENT INVENTION

An objective of the present invention is to provide a process of making a fabric composite from woven or knit fabric wastes via a needle punch reprocessing technology. The process comprises the following steps: providing a plurality of layers of woven or knit fabrics; stacking the layers of the woven or knit fabrics over each other; needle punching the fabrics to produce the fabric composite; and pressing the needle punched fabric composite.

Another objective of the present invention is to provide a process of making a fabric composite from woven or knit fabric wastes and shoddy and/or fibers via a needle punch reprocessing technology. The process comprises the following steps: providing a layer of woven or knit fabric; providing fibers and/or shoddy; blending and carding the fibers and/or shoddy into a fiber batt; needle punching the layer of the fabric and the fiber batt together to make the fabric composite; optionally laminating a plurality of the fabric composites together; and optionally pressing or molding the needle punched fabric composite.

Yet, another objective of the present invention is to provide a process of making a non-woven fabric composite. The process comprises the following steps: providing bicomponent fibers; blending the fibers to form a fiber batt; needle punching the fiber batt to tack the fibers in place; laminating a plurality of the fiber batts to form the fabric composite; and pressing or molding the fabric composite. The bicomponent fiber is composed of two components which are arranged in a side-by-side or core-sheath configuration.

Furthermore, another objective of the present invention is to provide a process of making a fabric composite from the fiber waste via a needle punching process. The process comprises the following steps: providing fibers; opening and blending the fibers to form a fiber batt; and spraying a biodegradable water-based gel-type spray onto top of the fiber batt. The process may further comprise steps of needle punching a layer of the woven or knit fabric and the sprayed fiber batt together to form the fabric composite; heating set the fabric composite at an elevated temperature to ensure durability; pressing a plurality of the fabric composites together; laminating the plurality of the fabric composites; and molding the fabric composites.

### BRIEF DESCRIPTION OF THE DRAWINGS

The processes of regenerating fabric and/or fiber wastes via a needle punching process are the disclosure herein of exemplary embodiments of the present invention. It is distinctly claimed in the claims at the conclusion of this patent description. The forgoing and other features and advantages of the present invention will become more apparent from the following detailed description taken in conjunction with the accompanying drawings.

FIG. 1 illustrates a process flow chart of regenerating woven or knit fabric waste derived from textile dead stock roll goods according to one embodiment of the present invention.

FIG. 2 illustrates a process flow chart of regenerating woven or knit fabric waste derived from rolled goods and fibers and/or shoddy according to another embodiment of the present invention.

FIG. 3 illustrates a process flow chart of regenerating shoddy or fiber wastes into a non-woven fabric composite according to another one embodiment of the present invention.

FIG. 4 illustrates a process flow chart of using natural nano cellulosic material binder for making fabric composite according to yet another one embodiment of the present invention.

FIG. 5a illustrates a photo of original knit fabric in the front of a 2-layer woven-and-shoddy fiber batt construction.

FIG. 5b illustrates a photo of front view of the needle punched knit fabric of the 2-layer woven-and-shoddy fiber batt construction.

FIG. 5c illustrates a photo of back view of the needle punched knit fabric with shoddy and fiber of the 2-layer woven-and-shoddy fiber batt construction.

FIG. 6a illustrates a photo of original woven fabric on the top in a 2-layer woven fabric construction.

FIG. 6b illustrates a photo of original woven fabric in the bottom in a 2-layer woven fabric construction.

FIG. 6c illustrates a photo of needle punched woven fabric on the top in a 2-layer woven fabric construction.

FIG. 6d illustrates a photo of needle punched woven fabric in the bottom in a 2-layer woven fabric construction.

FIG. 7a illustrates a 2-layer of woven or knit fabrics viewed in a cross section of needle punch process.

FIG. 7b illustrates a 2-layer of woven or knit fabric and shoddy/fiber batt viewed in a cross section of needle punch process.

FIG. 7c illustrates a 3-layer of woven or knit fabrics and shoddy/fiber batt viewed in a cross section of needle punch process.

### DETAILED DESCRIPTIONS OF THE INVENTION

All illustrations of the drawings are for the purpose of describing selected versions of the present invention and are not intended to limit the scope of the present invention.

The present invention is directed to processes of making fabric composites into regenerated fabrics and/or fibers. The process may incorporate a needle punching processing using textile virgin or dead stock, virgin or recycled materials including fiber, excess roll goods, second quality, etc. The fabric composite is made of more than one layer of fabrics and/or fibers, which may be of same material or different materials according to the present invention. The present invention is also related to the fabric products made by the processes as well. One of the fabric composite products is 3D product.

The processes developed by the present invention are “sustainable”, which contributes to a circular economy. In other words, the processes minimize un-desirable factors that are often implemented in conventional methods of making new fabrics, such as excessive clean water usage, chemical usage, and dye usage, for example, and significantly reduces fabric manufacturing time. The result of using water, dyes, and chemicals in the conventional methods create undesirable factors such as water pollution, freshwater use, air pollution, carbon emissions, greenhouse gas emissions, and energy use. Textile waste that is generally headed to a landfill or an incinerator is instead usable with value added and appreciated in the disclosed process of manufacturing a fabric. These fabrics may be considered “regenerated” fabrics. The regenerated fabrics may be used in many articles, including but not limited to apparel, accessories, home textiles, and/or footwear. Further, it is believed that the process of manufacture described herein, reduces the carbon footprint from the conventional methods used. Such regeneration of fabric may also save costs typically spent on excess inventory destruction and storage, and thereby increasing the value of dead stock.

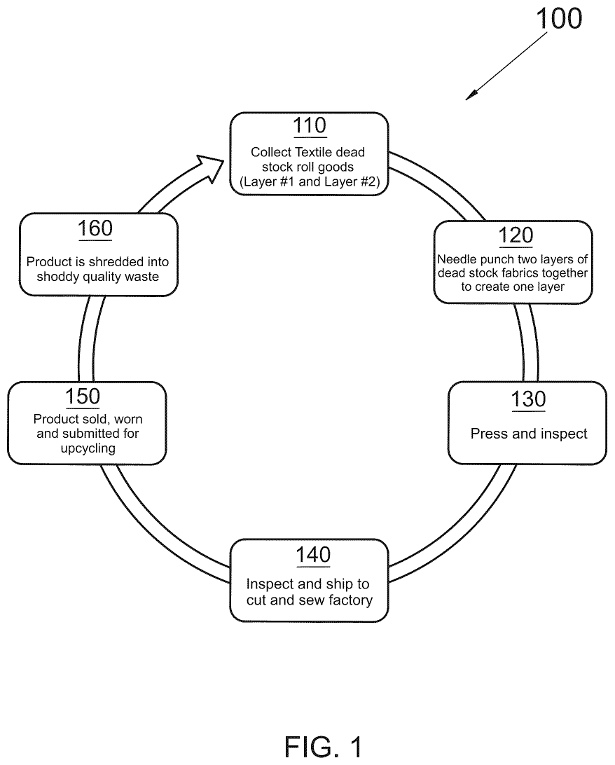

Referring to FIG. 1, there illustrated is a process flow chart 100 of regenerating woven or knit fabric derived from textile dead stock roll goods according to one embodiment of the present invention. In step 110 of the process, the textile dead stock roll goods are collected in layer #1. According to one exemplary embodiment, two layers of the collected woven or knit fabrics are stacked over each other. In step 120 of the process, the fabrics are needle punched together to form fabric composite. In step 130 which is an optional step, the needle punched fabric composite is pressed. In step 140, the fabric composite is shipped to a factory for re-use as a fabric for making a product. The product may be a 3D product, such as apparel, footwear, bags, home textile, etc. In step 150, the product is sold, worn, and submitted for upcycling to stay within a circular economy vs linear economy. In step 160, the product is shredded into shoddy-quality waste before being re-collected to start a new process, such as the process of 200.

As shown in FIG. 1, textile waste is processed using needle punching, which may include even patterns or irregular patterns, such as custom patterns by making needle patterns in the needle bed before needle punching.

In the above embodiment, the process to regenerate woven and knit fabric includes needle punching two layers of woven or knit fabrics stacked together. However, the layers of woven or knit fabrics in the process may comprise at least a first layer and it may comprise up to three layers of woven or knit construction.

In the embodiment, once the layers are needle punched, one or more fibers from the either layer (depending on desired aesthetical appearance) may appear on the technical face side of the second layer and produce a mechanical link between all layers by the interpenetration of the fibers by way of using barbed needles to punch and meld together the first layer with the up to three or even more additional layers. Additionally, and/or alternatively, the reverse fiber appearance may be achieved if the bottom layer is used as the top layer during processing. Also, both sides of the composite could be flipped after each pass of needle punching to achieve an even or uneven visual effect.

Notably, when using textile waste roll goods, any fiber content or fabric construction can be used.

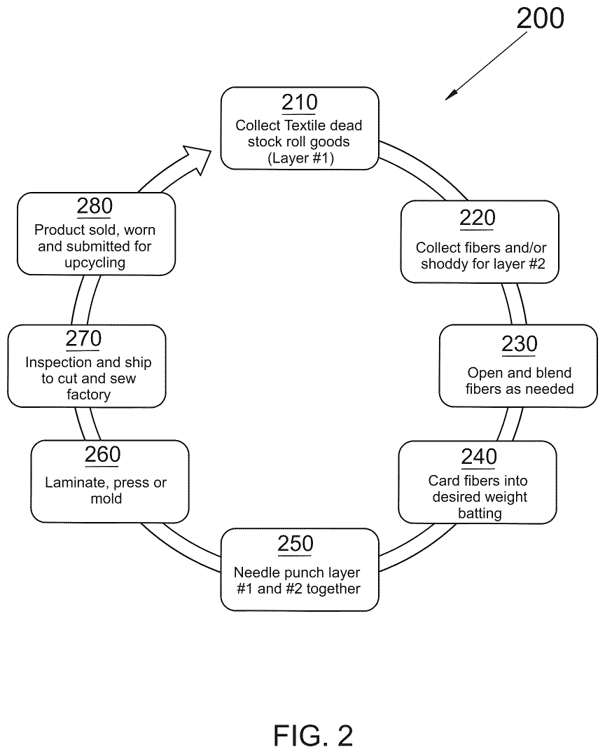

Referring to FIG. 2, there illustrated is a process flow chart 200 of regenerating woven or knit fabric waste derived from rolled goods and shoddy or fibers according to another embodiment of the present invention. In step 210, the woven or knit fabrics derived from textile dead stock roll goods are collected to form layer #1 and layer #3 if there are three layers in the fabric composite. In step 220, shoddy or fibers are collected as layer #2. In step 230, the fibers in layer #2 are blended as needed to form a uniform mixture. The content and weight of each layer may vary. In step 240, the fibers in layer #2 are carded into a fiber batt with desired weight. In step 250, the woven or knit fabrics in layer #1 and the fiber batt in layer #2 are stacked together before being needle punched to form a fabric composite. If there is #3 layer, the #3 layer is stacked with #1 and #2 layers together before being needle punched. In step 260, a plurality of the fabric composites is optionally laminated. The fabric composite is further pressed or molded either by itself or with other raw materials. In step 270, the fabric composite is inspected before being shipped to a factory for re-use as a fabric for making a product. The product may be 3D products, such as apparel, footwear, bags, home textiles, etc. In step 280, the product is sold, worn before being submitted for upcycling to stay within a circular economy vs linear economy.

As shown in FIG. 2, the content and length of the fiber used in the process 200 may be of any content and length without limitation. Any finer content of woven or knit construction can be used, but the fiber length needs to be longer than minimum 38 mm. The shoddy length could be less, but shoddy should be more than 27 mm in either length or width but not both. When using textile waste roll goods for layer #1, any fiber content or fabric construction can be used. Similarly, when using fiber, any fiber or yarn size can be used. But the fiber length less than 80 mm is preferred in some embodiments according to current known limitations (e.g., machine limitations, etc.).

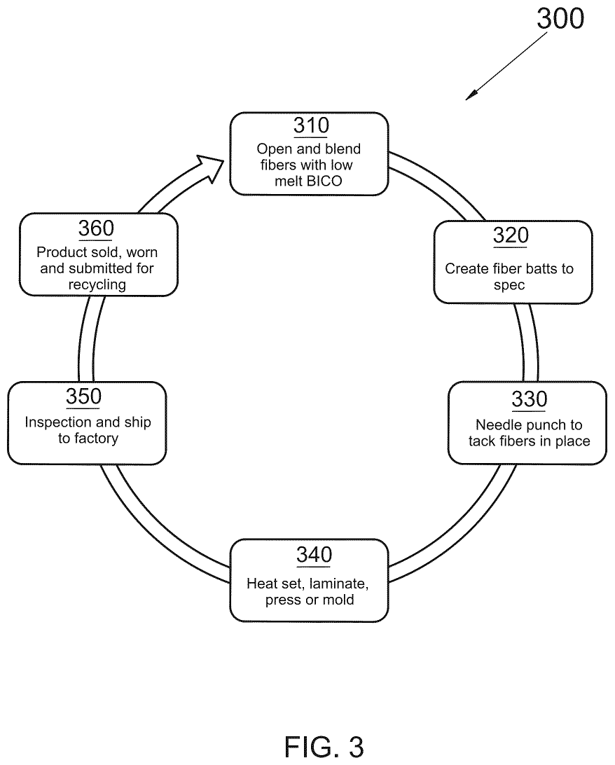

Referring to FIG. 3, there illustrated is a process flow chart 300 of regenerating low melt fiber mix into non-woven fabric composite according to another one embodiment of the present invention. The fiber in the low melt fiber mix composes two components (bicomponent) (BICO). The two components in the fiber are arranged either in a side-by-side or a core-sheath configuration. In step 310, the fibers are open and well blended. The weight and content may vary. In step 320, the fibers are made into a fiber batt before being inspected. In step 330, the fiber batt is needle punched to tack fibers in place. In step 340, the fiber matt is heat-set at an elevated temperature in an oven. Then optionally a plurality of the fiber batts is laminated followed by pressing or molding. In step 350, the product of fabric composite is inspected and shipped to a factory to make the fabric composite into a commercial product. The product may be 3D products, such as apparel, footwear, bags, home textiles, etc. In step 360, the product is sold, worn, and submitted for upcycling to stay within a circular economy vs linear economy.

A common starting material for making non-woven fiber composite via the process 300 is a synthetic fiber material, such as polyester, with a composition of two components (bicomponent, BICO). The two components may have different melting temperatures, or different chemical compositions, or different dye affinity.

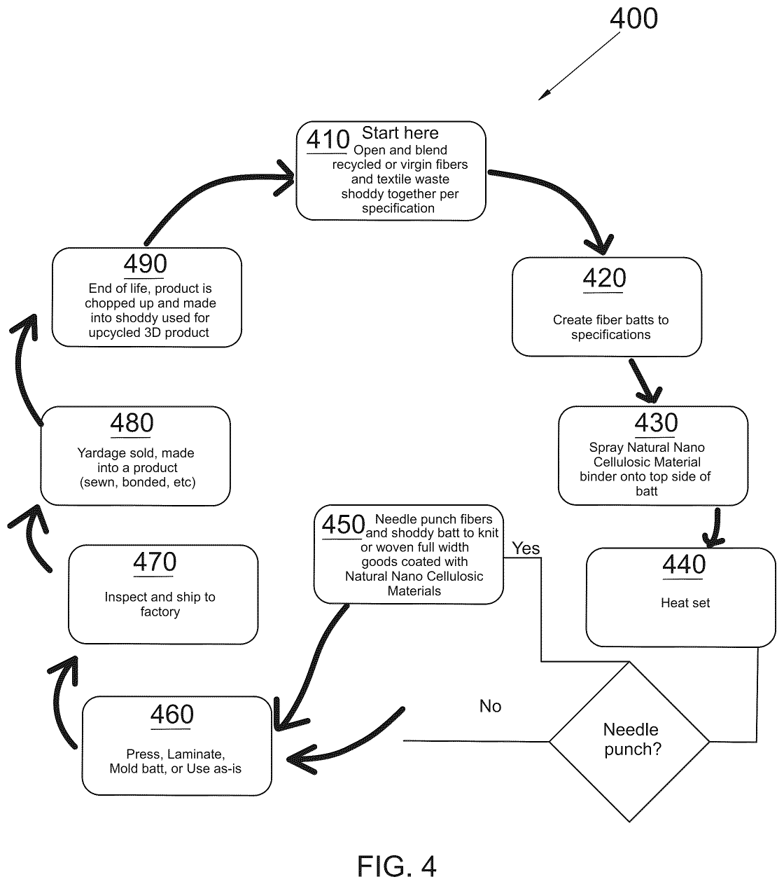

Referring to FIG. 4, there illustrated is a process flow chart 400 of using natural nano cellulosic material binder for making fabric composite according to yet another one embodiment of the present invention. In step 410, the recycled or virgin fibers and textile waste shoddy are open and blended to a specification. In step 420, a fiber batt is created to specification. In step 430, a natural nano cellulosic material binder is sprayed onto top side of the fiber batt. In step 440, the fiber batt is heat set at an elevated temperature. After completing step 440, depending on the product specification, some process requires step 450, in which the binder coated fiber batt and a layer of woven or knit fabric are needle punched together while some other process may skip the step 450, going directly to step 460. In step 460, there are several choices. In one choice, the fiber batt is pressed before a plurality of fiber batts is laminated and molded. In another choice, the fiber batt is used as it is without further processing. In step 470, the fabric composite is inspected and shipped to a factory for making a commercial product. In step 480, the fabric composite is made into a product, such as a 3D product by sewing and bonding, etc. In step 490, the product reaches end of its life and is made into shoddy for upcycling.

The natural nano cellulosic material binder used in process 400 is a bio-based gel-type spray. The binder comprises cellulosic fibers which will binds and secures and strengthened the webbed fiber batt. Furthermore, the gel increases the hand feel softness of the fiber composite product.

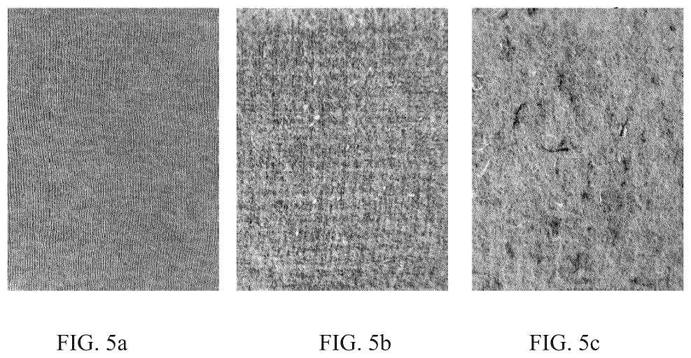

Referring to FIG. 5, there illustrated are photos of original knit fabric (FIG. 5a), front view of needle punched knit fabric (FIG. 5b), and back view of needle punched knit fabric with the shoddy/fiber (FIG. 5c) of a 2-layer woven-and-shoddy fiber batt construction.

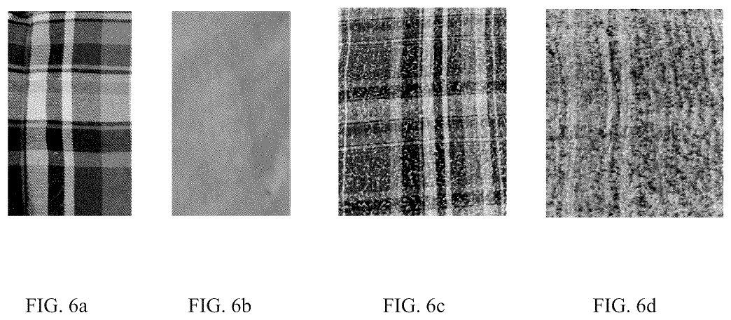

Referring to FIG. 6, there illustrated are photos of a 2-layer woven fabric construction. FIGS. 6a and 6b show the original woven fabrics on the top and bottom of the construction respectively before needle punching. FIGS. 6c and 6d show the woven fabrics on the top and bottom of the construction respectively after needle punching.

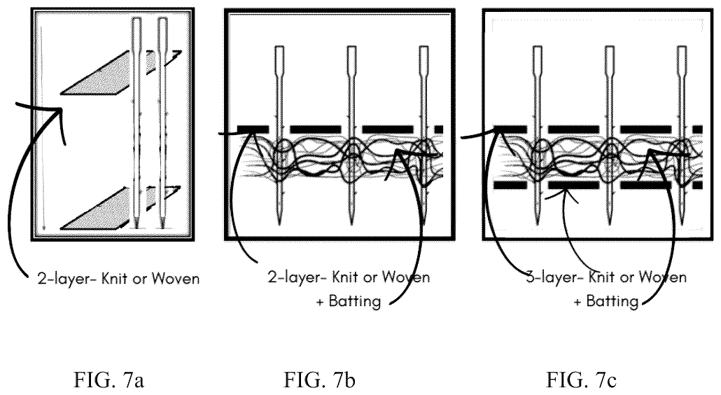

Referring to FIG. 7, there illustrated are cross sections of needle punch processes. In FIG. 7a, a 2-layer construction, which includes two layers of woven or knit fabrics, is in the process of needle punching. In FIG. 7b, a 2-layer construction, which includes one layer of woven or knit fabric and a shoddy/fiber batt, are in the process of needle punching. The woven or knit layer is located on the top while the shoddy/fiber batt is in the bottom. As shown in FIG. 7b, the needles penetrate both the woven or knit layer and the batt layer. In FIG. 7c, 3-layer construction, which includes two layers of woven or knit fabrics and a shoddy/fiber batt, is in the process of needle punching. As shown in FIG. 7c, the two layers of woven or knit fabrics sandwich the fiber batt. The needles penetrate the three layers.

Although several embodiments have been described herein to specify structural features and/or methodological acts, it is to be understood that the claims are not necessarily limited to the specific features or acts described. Rather, the specific features and acts are disclosed as illustrative forms of implementing the claimed subject matter.

1. A process of making a fabric composite, the process comprising the following steps:
providing a plurality of layers of woven or knit fabrics;
stacking the layers of the woven or knit fabrics over each other; and
needle punching the fabrics to make the fabric composite.

2. The process of claim 1 further comprising a step of pressing the needle punched fabric composite.

3. The process of claim 1, wherein the plurality of layers of the woven or knit fabrics comprises two layers.

4. The process of claim 1, wherein the plurality of layers of the woven or knit fabrics comprises three layers.

5. The process of claim 1, wherein the woven or knit fabric is made from fibers selected from natural, synthetic, and metal fibers.

6. A process of making a fabric composite, the process comprising the following steps:
providing a layer of woven or knit fabric;
providing fibers and/or shoddy;
blending and carding the fibers and/or shoddy into a fiber batt;
stacking the layer of the fabric and the fiber batt over each other;
needle punching the layer of the fabric and the fiber batt to make the fabric composite; and
pressing or molding the fabric composite.

7. The process of claim 6, wherein the woven or knit fabric is made from fibers selected from natural, synthetic, and metal fibers.

8. The process of claim 6 further comprising the following step:
laminating a plurality of the needle punched fabric composites together before the step of pressing or molding.

9. A process of making a non-woven fabric composite, the process comprising the following steps:
providing bicomponent fibers, wherein the fiber is composed of two components arranged in a side-by-side or core-sheath configuration;
blending the fibers to form a fiber batt;
needle punching the fiber batt to tack the fibers in place;
laminating a plurality of the fiber batts to form the fabric composite; and
pressing or molding the fabric composite.

10. The process of claim 9, wherein the bicomponent fiber is selected from a group including synthetic, biosynthetic and natural fibers.

11. The process of claim 9, wherein the two components of the fiber have different melting temperatures.

12. The process of claim 9, wherein the two components of the fiber have different chemical compositions.

13. The process of claim 9, wherein the two components of the fiber have different dye affinity.

14. A process of making a fabric composite, the process comprising the following steps:
providing fibers;
providing a biodegradable water-based gel-type spray;
opening and blending the fibers to form a fiber batt;
spraying the spray onto top of the fiber batt; and
heating set the sprayed fiber batt at an elevated temperature.

15. The process of claim 14, wherein the gel-type spray is selected from natural nano cellulosic material binders, the cellulosic material binders including cellulosic fibers.

16. The process of claim 14 further comprising the following steps:
providing a layer of woven or knit fabric;
stacking the layer of the woven or knit fabric and the sprayed fiber batt over each other; and
needle punching the layer of the woven or knit fabric and the sprayed fiber batt together to form the fabric composite.

17. The process of claim 14 further comprising the following steps:
pressing the fabric composite;
laminating a plurality of the fabric composites and
molding the plurality of the fabric composites.

18. The process of claim 16 further comprising the following steps:
pressing the fabric composite;
laminating a plurality of the fabric composites and molding the plurality of the fabric composites.

19. The process of claim 14, wherein the fibers are selected from a group including recycled fibers, virgin fibers, textile waste shoddy, and a combination thereof.

20. A fabric composite made in the process according to claim 16, the fabric composite comprising:
at least one layer of woven or knit fabric; and
a fiber batt including fibers and/or shoddy, wherein the fiber batt is coated by a natural nano cellulosic material binder, the cellulosic material binder comprising cellulosic fibers, and wherein the woven or knit fabric and the binder coated fiber batt are needle punched together to form the fabric composite.

21. The fabric composite of claim 20, wherein a plurality of the fabric composites is pressed and laminated together.

22. The fabric composite of claim 20, wherein the fibers and/or shoddy is selected from a group including natural fibers and synthetic fibers.

23. The fabric composite of claim 20, wherein the fiber batt further comprises a filler, the filler including the cellulosic material binder.
